(19) United States
(12) Patent Application Publication
(10) Pub. No.: US 2026/0172723 A1
(43) Pub. Date: Jun. 18, 2026

(54) PHOTOELECTRIC CONVERSION DEVICE

(71) Applicant: CANON KABUSHIKI KAISHA, Tokyo (JP)

(72) Inventors: KEISUKE TAKAHASHI, Tokyo (JP); TOMOYA KOKADO, Kanagawa (JP)

(21) Appl. No.: 19/419,429

(22) Filed: Dec. 15, 2025

(30) Foreign Application Priority Data
Dec. 18, 2024 (JP) 2024-221691

(51) Int. Cl. H04N 25/78; H04N 25/616; H04N 25/63; H04N 25/705

(52) U.S. Cl. CPC H04N 25/78; H04N 25/705; H04N 25/616; H04N 25/63

(57) ABSTRACT

A photoelectric conversion device includes a pixel array, first and second output lines, and a correction value generation unit. Each row of first and second regions in the pixel array includes an effective pixel region and a correction signal acquisition region. The first and second output lines are connected to pixels in the first and second regions, respectively. The second region includes a first pixel row and a second pixel row adjacent to the first region. The correction value generation unit generates a correction value used for black level correction of a signal output from a pixel of the first pixel row based on a first correction coefficient and a correction signal, and generates a correction value used for black level correction of a signal output from a pixel of the second pixel row based on a second correction coefficient different from the first correction coefficient and the correction signal.

### BACKGROUND

### Field of the Technology

The present disclosure relates to a photoelectric conversion device.

### Description of the Related Art

Japanese Patent Laid-Open No. 2010-098516 discloses an imaging element having a plurality of pixel circuits arranged to form a plurality of rows and a plurality of columns, and a plurality of signal lines to which signals are read out from the pixel circuits. In the imaging element disclosed in Japanese Patent Laid-Open No. 2010-098516, a region in which a plurality of pixel circuits are arranged is divided into a first pixel region and a second pixel region. In one column, pixels arranged in the first pixel region and pixels arranged in the second pixel region are connected to different signal lines. As a result, the parasitic resistance and the parasitic capacitance are reduced, and the settling time is reduced, so that the speed of reading can be increased.

In a photoelectric conversion device in which readout is performed by different output lines for each region as disclosed in Japanese Patent Laid-Open No. 2010-098516, a difference may occur in levels of output signals in the vicinity of the boundary of the regions. This may reduce the quality of the output image.

### SUMMARY

The present disclosure is directed to provide a photoelectric conversion device capable of improving the quality of an output image.

According to one aspect of the present disclosure, there is provided a photoelectric conversion device including a pixel array including a plurality of pixels arranged to form a plurality of rows and a plurality of columns, a first output line and a second output line each arranged to correspond to one of the plurality of columns, and a correction value generation unit configured to generate a correction value used for black level correction of a signal output from the pixel array. The pixel array includes a first region including consecutive rows among the plurality of rows and a second region including other consecutive rows among the plurality of rows, the second region being adjacent to the first region. Each row of the first region and the second region includes an effective pixel region configured to output a signal according to incident light by photoelectric conversion and a correction signal acquisition region configured to output a correction signal. The first output line is connected to a pixel in the first region and is not connected to any pixel in the second region. The second output line is connected to a pixel in the second region and is not connected to any pixel in the first region. The second region includes a first pixel row and a second pixel row that is adjacent to the first region. The correction value generation unit generates a correction value used for black level correction of a signal output from a pixel of the first pixel row based on a first correction coefficient and the correction signal, and generates a correction value used for black level correction of a signal output from a pixel of the second pixel row based on a second correction coefficient different from the first correction coefficient and the correction signal.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration example of a photoelectric conversion device according to a first embodiment.

FIG. 2 is a perspective view illustrating a configuration example of the photoelectric conversion device according to the first embodiment.

FIG. 3 is a schematic diagram illustrating a configuration example of a pixel array according to the first embodiment.

FIG. 4 is a circuit diagram illustrating a configuration example of a pixel according to the first embodiment.

FIGS. 5A and 5B are diagrams schematically illustrating signal levels of respective rows before correction.

FIGS. 6A and 6B are diagrams schematically illustrating signal levels of respective rows after correction.

FIGS. 7A and 7B are diagrams schematically illustrating signal levels of respective rows before correction in a case where step-like noise occurs due to output line splitting.

FIG. 8 is a block diagram of a signal processing unit according to the first embodiment.

FIG. 9 is a block diagram of a correction value generation unit according to the first embodiment.

FIG. 10 is a flowchart illustrating a black level correction method according to the first embodiment.

FIGS. 11A and 11B are diagrams schematically illustrating signal levels of respective rows before correction and a correction coefficient switching signal according to the first embodiment.

FIGS. 12A and 12B are diagrams schematically illustrating signal levels of respective rows after correction according to the first embodiment.

FIG. 13 is a block diagram of a correction value generation unit according to a second embodiment.

FIG. 14 is a flowchart illustrating a black level correction method according to the second embodiment.

FIGS. 15A and 15B are diagrams schematically illustrating signal levels of respective rows before correction and the correction coefficient switching signal according to the second embodiment.

FIG. 16 is a block diagram illustrating a configuration example of a photoelectric conversion device according to a third embodiment.

FIGS. 17A and 17B are diagrams schematically illustrating signal levels of respective rows before correction and the correction coefficient switching signal according to the third embodiment.

FIG. 18 is a diagram illustrating a configuration example of an imaging system according to a fourth embodiment.

FIG. 19 is a block diagram illustrating a schematic configuration of equipment according to a fifth embodiment.

FIGS. 20A and 20B are block diagrams illustrating a schematic configuration of equipment according to a sixth embodiment.

### DESCRIPTION OF THE EMBODIMENTS

Hereinafter, embodiments of the present disclosure will be described with reference to the drawings. The same or corresponding elements are denoted by the same reference numerals throughout the several drawings, and the description thereof may be omitted or simplified.

### First Embodiment

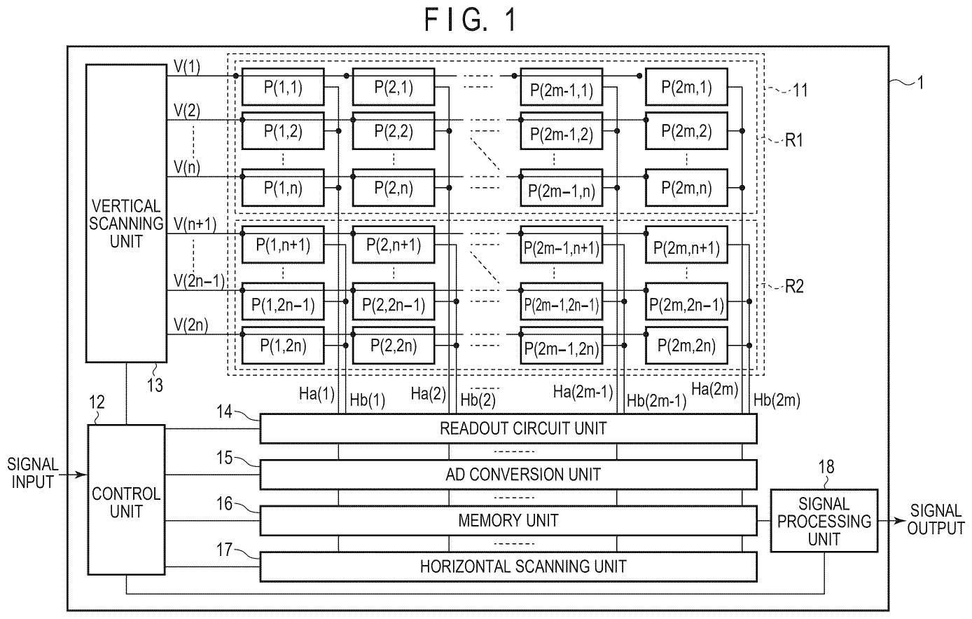

FIG. 1 is a block diagram illustrating a configuration example of a photoelectric conversion device 1 according to the present embodiment. The photoelectric conversion device 1 includes a pixel array 11, a control unit 12, a vertical scanning unit 13, a readout circuit unit 14, an AD conversion unit (analog-to-digital conversion unit) 15, a memory unit 16, a horizontal scanning unit 17, and a signal processing unit 18.

The pixel array 11 includes a plurality of pixels P arranged to form a plurality of rows and a plurality of columns. The pixel P may include a photoelectric conversion element. In FIG. 1, pixels P arranged in a matrix of 2m columns×2n rows are illustrated as rectangular blocks. In FIG. 1, a coordinate represented by (column number, row number) is assigned as a reference numeral of a pixel. In this specification, a direction in which each row extends (row direction) is defined as a horizontal direction, and a direction in which each column extends (column direction) is defined as a vertical direction. Further, it is assumed that the row number of the uppermost row is the first row, and the column number of the leftmost column is the first column.

The vertical scanning unit 13 is a control circuit (pixel control unit) that operates in response to a control signal from the control unit 12 and drives the pixels P constituting the pixel array 11 on a row basis. The vertical scanning unit 13 supplies control signals to the pixels P on a row basis via control lines V(1) to V(2n) arranged for each row of the pixel array 11. The vertical scanning unit 13 may be configured using a shift register or an address decoder. Each of the control lines V(1) to V(2n) may include a plurality of signal lines. In the notations of the control lines V, numerical values in parentheses indicate row numbers.

The photoelectric conversion device 1 includes vertical output lines Ha(1) to Ha(2m) respectively corresponding to the first column to the 2m-th column, and vertical output lines Hb(1) to Hb(2m) respectively corresponding to the first column to the 2m-th column. Each of the vertical output lines Ha(1) to Ha(2m) (first output line) is connected to the pixels P of the corresponding column in a region R1 (first region) from the first row to the n-th row. Each of the vertical output lines Hb(1) to Hb(2m) (second output line) is connected to the pixels P of the corresponding column in a region R2 (second region) from the (n+1)-th row to the 2n-th row. That is, in the present embodiment, two vertical output lines are arranged so as to correspond to the pixels P in one column. In the notations of the vertical output lines Ha and Hb, numerical values in parentheses indicate column numbers. Each of the regions R1, R2 includes a plurality of consecutive rows. In the example of FIG. 1, the numbers of rows of the regions R1 and R2 are the same, but may be different.

The vertical scanning unit 13 is connected to 2m pixels P arranged in a corresponding row via the control lines V(1) to V(2n), and selects a row to be reset or a row from which signals are read. The pixels P selected as the row to be reset are reset and start exposure. The pixels P in the row selected as the row from which the signals are read out simultaneously output the signals to the readout circuit unit 14 via the corresponding vertical output lines Ha(1) to Ha(2m) or the corresponding vertical output lines Hb(1) to Hb(2m). In the reset and signal readout, the vertical scanning unit 13 sequentially selects the control lines V(1) to V(2n). That is, the vertical scanning unit 13 performs control to scan the plurality of pixels P so that the plurality of pixels P sequentially output signals on a row basis.

The readout circuit unit 14 is a circuit that reads out analog signals from the pixels P in each column. The readout circuit unit 14 may include an amplifier circuit that amplifies the signals output from the pixels P. In addition, the readout circuit unit 14 may include a switch that switches a vertical output line from which signals are read out. For example, the readout circuit unit 14 may be capable of switching between a state in which signals are read out from the vertical output lines Ha(1) to Ha(2m) and a state in which signals are read out from the vertical output lines Hb(1) to Hb(2m).

The AD conversion unit 15 converts the analog signals output from the readout circuit unit 14 into digital signals. The memory unit 16 temporarily holds the digital signals output from the AD conversion unit 15. The AD conversion and the holding of the digital signals may be performed for each column. That is, the AD conversion unit 15 may include an AD conversion circuit corresponding to each column. The memory unit 16 may include memories corresponding to each column.

The horizontal scanning unit 17 is a circuit that operates in response to a control signal from the control unit 12, and sequentially transfers the digital signals held in the memories of the respective columns of the memory unit 16 to the signal processing unit 18 on a column basis. The horizontal scanning unit 17 may be configured using a shift register or an address decoder. The digital signal of the address designated by the horizontal scanning unit 17 is sequentially read out from the memory unit 16 to the signal processing unit 18.

The signal processing unit 18 is a signal processing circuit that performs various kinds of digital signal processing for reducing noise generated in the pixel array 11, the readout circuit unit 14, the AD conversion unit 15, the memory unit 16, the horizontal scanning unit 17, and the like. The signal processing unit 18 outputs the processed signals to the outside of the photoelectric conversion device 1 in a predetermined format.

The control unit 12 is a control circuit that acquires a signal indicating setting information such as imaging conditions when the photoelectric conversion device 1 performs imaging, and generates a control signal based on the setting information. The control unit 12 controls the respective units by outputting control signals to the vertical scanning unit 13, the readout circuit unit 14, the AD conversion unit 15, the memory unit 16, the horizontal scanning unit 17, and the signal processing unit 18.

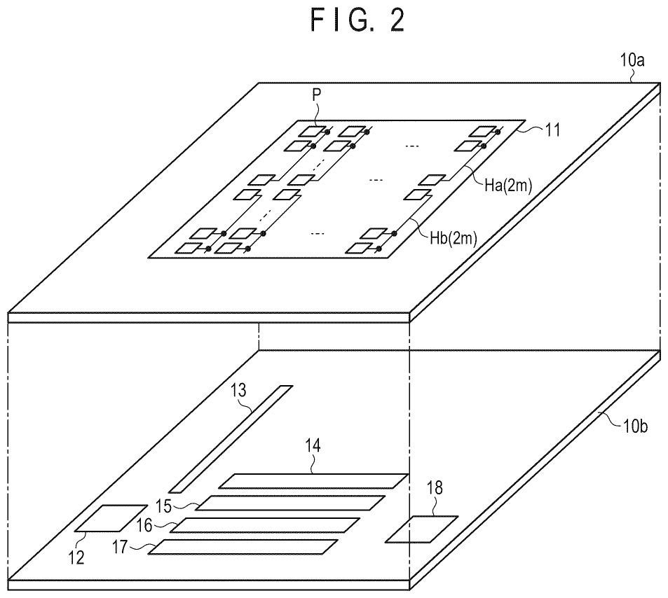

The photoelectric conversion device 1 according to the present embodiment may be formed in one substrate or may be a stacked type in which a plurality of substrates are stacked. FIG. 2 is a perspective view illustrating a configuration example of the stacked photoelectric conversion device 1. As illustrated in FIG. 2, the photoelectric conversion device 1 may be a stacked photoelectric conversion device in which the pixel substrate 10a and the circuit substrate 10b are stacked and electrically connected to each other. The pixel substrate 10a and the circuit substrate 10b may be semiconductor substrates such as silicon.

The pixel array 11 among the constituent elements of the photoelectric conversion device 1 may be arranged in the pixel substrate 10a (first substrate). In the pixel substrate 10a, at least a part of wirings constituting the vertical output lines Ha(1) to Ha(2m) and the vertical output lines Hb(1) to Hb(2m) is arranged. In addition, among the constituent elements of the photoelectric conversion device 1, the control unit 12, the vertical scanning unit 13, the readout circuit unit 14, the AD conversion unit 15, the memory unit 16, the horizontal scanning unit 17, and the signal processing unit 18 may be arranged in the circuit substrate 10b (second substrate). The vertical output lines Ha(1) to Ha(2m) and the vertical output lines Hb(1) to Hb(2m) are electrically connected to the readout circuit unit 14.

By configuring the photoelectric conversion device 1 as described above, an appropriate manufacturing process can be selected for each of the analog part including the pixel array 11 and the logic part including the signal processing unit 18 when the photoelectric conversion device 1 is manufactured. As a result, the characteristics of each part of the photoelectric conversion device 1 are improved. Therefore, the photoelectric conversion device 1 with improved image quality can be realized.

As described above, the photoelectric conversion device 1 includes the pixel array 11 and the signal processing unit 18, but the configuration of the photoelectric conversion device 1 is not limited thereto. The signal processing unit 18 may be arranged in a signal processing device different from a device including the pixel array 11. In addition, the signal processing unit 18 may be arranged in a signal processing device external to the photoelectric conversion device 1, and in this case, the signal processing device corrects signals output from the photoelectric conversion device 1 to generate image data or the like. The signal processing unit 18 may be realized by a computer including a processor (a central processing unit (CPU), a micro processing unit (MPU), or the like). Also, the signal processing unit 18 may be realized by a circuit such as an application specific integrated circuit (ASIC).

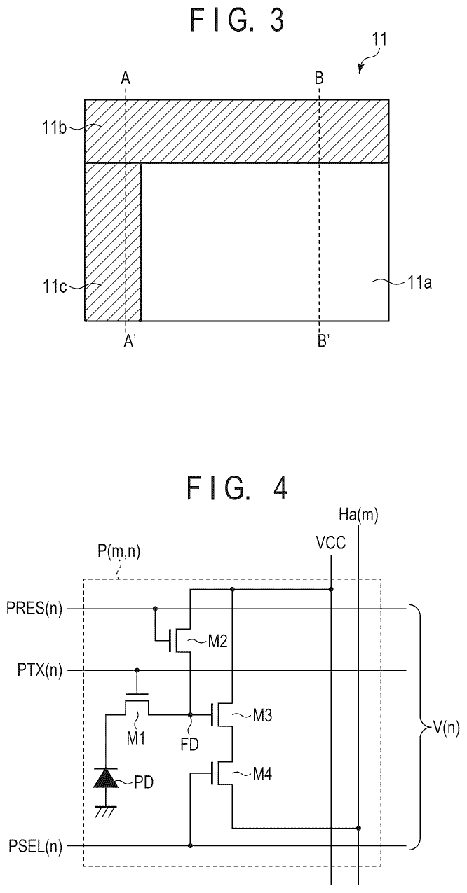

FIG. 3 is a schematic diagram illustrating a configuration example of the pixel array 11 according to the present embodiment. The pixel array 11 includes an effective pixel region 11a and correction signal acquisition regions 11b and 11c. The effective pixel region 11a is a region in which effective pixels including photoelectric conversion elements are arranged. The effective pixel outputs a signal corresponding to light that passes through an optical system such as a lens and enters the pixel array 11. The correction signal acquisition region 11b is a region in which correction pixels that output correction signals used for black level correction are arranged. The correction signal acquisition regions 11b and 11c may be, for example, light shielding regions in which incident light to the photoelectric conversion element is optically shielded by arranging a light shielding portion such as a light shielding film on the photoelectric conversion element. Such a light shielding region may also be referred to as an optical black (OB) region.

The correction signal acquisition region 11c is arranged on the left side of the effective pixel region 11a so as to correspond to each row of the effective pixel region 11a. The correction signal acquisition region 11c may be referred to as an HOB region. The correction signal acquisition region 11c may be arranged on the right side of the effective pixel region 11a.

The correction signal acquisition region 11b is arranged above the effective pixel region 11a and the correction signal acquisition region 11c. The correction signal acquisition region 11b may be referred to as a VOB region. The correction signal acquisition region 11b may be arranged below the effective pixel region 11a and the correction signal acquisition region 11c.

The correction signal acquisition regions 11b and 11c are not limited to the OB region in which the photoelectric conversion element is shielded from light. For example, the correction signal acquisition regions 11b and 11c may be dummy regions having no photoelectric conversion element. The pixel P in the dummy region has the same configuration as that obtained by excluding the photoelectric conversion element from the effective pixel in the effective pixel region 11a. In this case, the correction signal acquisition region 11c may be referred to as a horizontal dummy region, and the correction signal acquisition region 11b may be referred to as a vertical dummy region. The correction signal acquisition regions 11b and 11c may include both the OB region and the dummy region.

FIG. 4 is a circuit diagram illustrating a configuration example of the pixel P according to the first embodiment. FIG. 4 illustrates the pixel P(m,n) arranged in the m-th row and the n-th column of the pixel array 11, but other pixels P also have the same configuration. The pixel P includes a photoelectric conversion element PD, a transfer transistor M1, a reset transistor M2, an amplification transistor M3, and a selection transistor M4.

The photoelectric conversion element PD photoelectrically converts incident light to generate and accumulate charges according to the incident light. The photoelectric conversion element PD is, for example, a photodiode. Here, it is assumed that the photoelectric conversion element PD is formed of a photodiode.

An anode of the photodiode constituting the photoelectric conversion element PD is connected to a ground node. A cathode of the photodiode constituting the photoelectric conversion element PD is connected to a source of the transfer transistor M1. A drain of the transfer transistor M1 is connected to a source of the reset transistor M2 and a gate of the amplification transistor M3. A connection node between the drain of the transfer transistor M1, the source of the reset transistor M2, and the gate of the amplification transistor M3 is a so-called floating diffusion portion FD.

A drain of the reset transistor M2 and a drain of the amplification transistor M3 are connected to a power supply voltage node (voltage VCC). A source of the amplification transistor M3 is connected to a drain of the selection transistor M4. A source of the selection transistor M4 is connected to the vertical output line Ha(m).

In the case of the pixel configuration illustrated in FIG. 4, each of the control lines arranged in each row of the pixel array 11 includes a transfer gate signal line, a reset signal line, and a selection signal line. The transfer gate signal line of the n-th row is connected to gates of the transfer transistors M1 of the pixels P(1,n) to P(2m,n) of the n-th row. The transfer gate signal line of the n-th row supplies a control signal PTX(n) output from the vertical scanning unit 13 to the gates of the transfer transistors M1 of the pixels P(1,n) to P(2m,n).

The reset signal line of the n-th row is connected to gates of the reset transistors M2 of the pixels P(1,n) to P(2m,n) of the n-th row. The reset signal line of the n-th row supplies a control signal PRES(n) output from the vertical scanning unit 13 to the gates of the reset transistors M2 of the pixels P(1,n) to P(2m,n).

The selection signal line of the n-th row is connected to gates of the selection transistors M4 of the pixels P(1,n) to P(2m,n) of the n-th row. The selection signal line of the n-th row supplies a control signal PSEL(n) output from the vertical scanning unit 13 to the gates of the selection transistors M4 of the pixels P(1,n) to P(2m,n). As described above, common control signals are supplied from the vertical scanning unit 13 to the pixels P in the same row.

In a case where each transistor is formed of an N-channel transistor, when a high-level control signal is supplied from the vertical scanning unit 13, the corresponding transistor is turned on. When a low-level control signal is supplied from the vertical scanning unit 13, the corresponding transistor is turned off. Each transistor constituting the pixel P may be the N-channel transistor, but may be a P-channel transistor.

The photoelectric conversion element PD converts (photoelectrically converts) the incident light into charges of an amount corresponding to the amount of the incident light, and accumulates the generated charges. When the transfer transistor M1 is turned on (conduction state), the charges held by the photoelectric conversion element PD is transferred to the floating diffusion portion FD. The floating diffusion portion FD includes a capacitance component, holds the charges transferred from the photoelectric conversion element PD in its capacitance, and has a potential corresponding to the amount of the charges by charge-to-voltage conversion by the capacitance.

The source of the amplification transistor M3 is supplied with a bias current from a current source (not illustrated) via the vertical output line Ha(m) and the selection transistor M4. Also, a power supply voltage (voltage VCC) is supplied to the drain of the amplification transistor M3. That is, the amplification transistor M3 constitutes a source follower circuit in which the gate thereof is an input node. Accordingly, the amplification transistor M3 outputs a signal based on the potential of the floating diffusion portion FD to the vertical output line Ha(m) via the selection transistor M4.

The reset transistor M2 is turned on (conduction state) to reset the floating diffusion portion FD to a potential corresponding to the power supply voltage (voltage VCC). By turning on the transfer transistor M1 simultaneously with the reset transistor M2, the photoelectric conversion element PD can be reset to a potential corresponding to the voltage VCC. The selection transistor M4 switches the connection between the amplification transistor M3 and the vertical output line Ha(m).

The photoelectric conversion element PD is reset to a potential corresponding to the power supply voltage (voltage VCC) by turning on the transfer transistor M1 and the reset transistor M2. When the transfer transistor M1 is turned off from the reset state, the reset state of the photoelectric conversion element PD is canceled, and exposure (accumulation of charges) in the photoelectric conversion element PD is started.

In the readout operation of the pixel P, readout of a noise signal (N-signal) and readout of a signal based on incident light (S-signal) are performed. The reading of the N-signal is performed by canceling the reset state of the floating diffusion portion FD and then outputting a signal corresponding to the potential of the floating diffusion portion FD in the reset state to the vertical output line Ha(m) by the amplification transistor M3. The reset state of the floating diffusion portion FD is canceled by turning off the reset transistor M2.

The readout of the S-signal is performed by transferring the charge held by the photoelectric conversion element PD to the floating diffusion portion FD after the readout of the N-signal, and outputting a signal corresponding to the amount of the charge transferred to the floating diffusion portion FD to the vertical output line Ha(m).

By performing correlated double sampling processing (S-N) on the S-signal and the N-signal read out in this manner, it is possible to obtain a pixel signal in which reset noise of the floating diffusion portion FD is reduced. The signal processing unit 18 can reduce reset noise by performing correlated double sampling processing or the like.

The signal read out as described above may include fixed pattern noise. The fixed pattern noise may be caused by, for example, variations in dark current generated in the photoelectric conversion element PD, variations in power supply impedance, signal delay, and the like in a circuit configuring the photoelectric conversion device 1. Also, fixed pattern noise may vary with a predetermined regularity depending on the row or column, and such a state is referred to as shading.

After performing the processing of reducing the reset noise, the signal processing unit 18 generates a correction value for correcting the fixed pattern noise by averaging a plurality of correction signals acquired from a predetermined region in the correction signal acquisition regions 11b and 11c for each row or each column. Then, the signal processing unit 18 performs correction processing for reducing the fixed pattern noise by using the correction value.

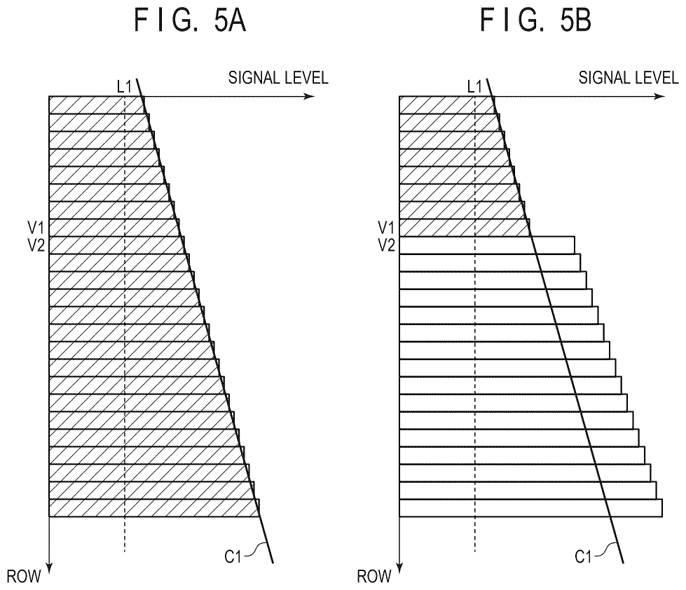

FIGS. 5A and 5B are diagrams schematically illustrating signal levels of respective rows before correction. In FIGS. 5A and 5B, the vertical axis indicates the position of the row of the pixel P from which the signal is output, and the horizontal axis indicates the signal level. FIG. 5A illustrates the distribution of the signal levels of the output signals from the pixels P on the line A-A′ in FIG. 3, and FIG. 5B illustrates the distribution of the signal levels of the output signals from the pixels P on the line B-B′ in FIG. 3. In FIGS. 5A and 5B, hatched boxes indicate output signals of the correction signal acquisition regions 11b and 11c, and unhatched boxes indicate output signals of the effective pixel region 11a. A row V1 illustrated in FIGS. 5A and 5B is the lowermost row of the correction signal acquisition region 11b, and a row V2 illustrated in FIGS. 5A and 5B is the uppermost row of the effective pixel region 11a.

As illustrated in FIG. 5A, in this example, shading occurs such that the larger the row number, that is, the lower the row, the higher the signal level. A reference signal level L1 in FIG. 5A is a reference value of the black level. A difference between a correction value level C1 and the reference signal level L1 corresponds to a shading component to be reduced in the fixed pattern noise correction processing. In FIG. 5B, there is a difference in the signal level between the row V1 of the correction signal acquisition region 11b and the row V2 of the effective pixel region 11a. This level difference indicates a signal component due to incident light.

In the following description, as in FIGS. 5A and 5B, a diagram schematically illustrating signal levels of respective rows may be used. In this case, redundant description will be appropriately omitted or simplified.

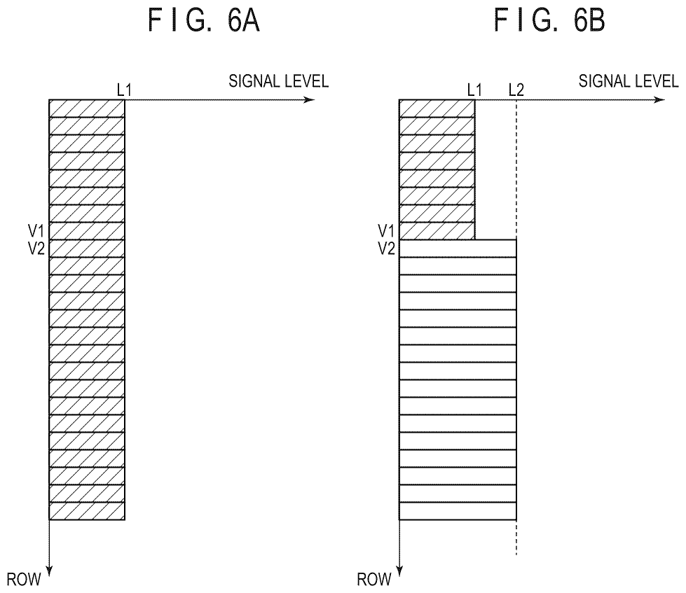

FIGS. 6A and 6B are diagrams schematically illustrating signal levels of respective rows after correction of the fixed pattern noise. In this correction, the difference between the correction value level C1 and the reference signal level L1 is subtracted from the output signal. FIG. 6A illustrates the distribution of the corrected signal levels of the output signals from the pixels P on the line A-A′ in FIG. 3. As illustrated in FIG. 6A, the shading component is removed, and the signal level of each row is uniform. FIG. 6B illustrates the distribution of the corrected signal levels of the output signals from the pixels P on the line B-B′ in FIG. 3. As illustrated in FIG. 6B, the shading component is removed, and the signal level is uniform in each of the correction signal acquisition region 11b and the effective pixel region 11a. A signal level L2 in FIG. 6B indicates a signal component due to incident light.

Here, the correction value level C1 can be acquired, for example, by performing integral averaging on the output signal of the correction signal acquisition region 11b for each row. However, the output signal of the correction signal acquisition region 11b may include random noise different for each pixel P. Therefore, in the case where the processing of integral averaging on the output signal of the correction signal acquisition region 11b for each row is employed, there is a possibility that the integral average value varies due to the random noise and thus the correction accuracy decreases. Therefore, in order to reduce the influence of the random noise, digital low-pass filter processing may be performed on the output signals of the correction signal acquisition region 11b. This can improve the correction accuracy. An example of the digital low-pass filter is an infinite impulse response (IIR) filter.

In the present embodiment, two vertical output lines Ha and Hb are arranged so as to correspond to pixels P in one column. There is a case where a characteristic difference occurs in the output signal between the pixel P from which the signal is read to the vertical output line Ha and the pixel P from which the signal is read to the vertical output line Hb due to the difference in the path through which the signal is transmitted. Due to this characteristic difference, a step in signal level may occur at the boundary between the region R1 in which the pixels P from which signals are read out to the vertical output line Ha are arranged and the region R2 in which the pixels P from which signals are read out to the vertical output line Hb are arranged. This step appears linearly in the vicinity of the center of the image, and is therefore likely to be visually recognized by the viewer. In the configuration of the present embodiment, the step due to the output line splitting caused by such a factor may become a factor of deterioration in image quality. FIG. 5A, FIG. 5B, FIG. 6A, and FIG. 6B exemplify a case where no step due to the output line splitting occurs or the influence of the output line splitting is negligibly small, but the influence of the step due to the output line splitting may be non-negligibly large. In addition, even if correction is performed by signal processing using the low-pass filter such as the IIR filter as described above, correction for the step due to the output line splitting may be insufficient.

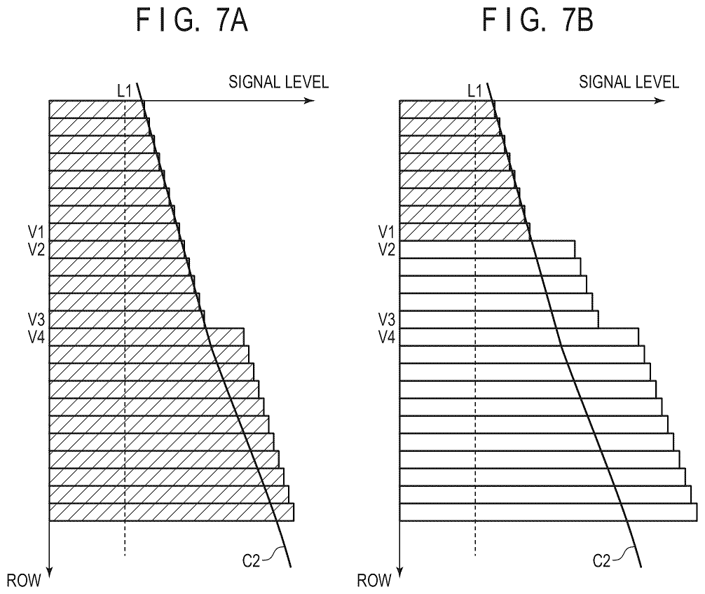

FIGS. 7A and 7B are diagrams schematically illustrating signal levels of respective rows before correction in a case where step-like noise occurs due to the output line splitting. In FIGS. 7A and 7B, a row V3 is the lowermost row of the region R1 in which signals are read to the vertical output line Ha, and a row V4 is the uppermost row of the region R2 in which signals are read to the vertical output line Hb. As illustrated in FIGS. 7A and 7B, there is a difference in signal level between the row V3 and the row V4. This level difference indicates the step due to the output line splitting resulting from switching of the vertical output lines Ha and Hb from which signals are read. The correction value level C2 generated by the IIR filter or the like using the output signals illustrated in FIG. 7A does not follow the step due to the output line splitting. Therefore, in the examples of FIGS. 7A and 7B, the correction for the step due to the output line splitting may be insufficient.

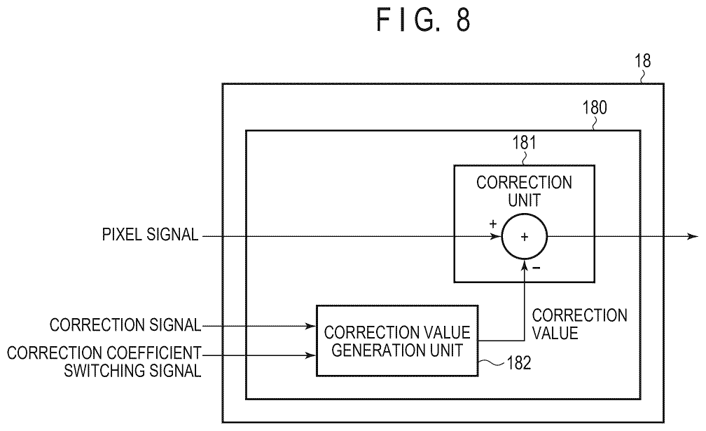

Hereinafter, a configuration example and a correction method of the signal processing unit 18 that can appropriately perform correction even when the step due to the output line splitting is generated will be described. FIG. 8 is a block diagram of the signal processing unit 18 according to the present embodiment. The signal processing unit 18 includes a processing circuit 180. The processing circuit 180 includes a correction unit 181 and a correction value generation unit 182.

The correction value generation unit 182 generates a correction value used for black level correction based on the correction signals acquired in the correction signal acquisition regions 11b and 11c and a correction coefficient switching signal. The correction unit 181 performs the black level correction of the pixel signal by subtracting the correction value from the pixel signal acquired in the effective pixel region 11a.

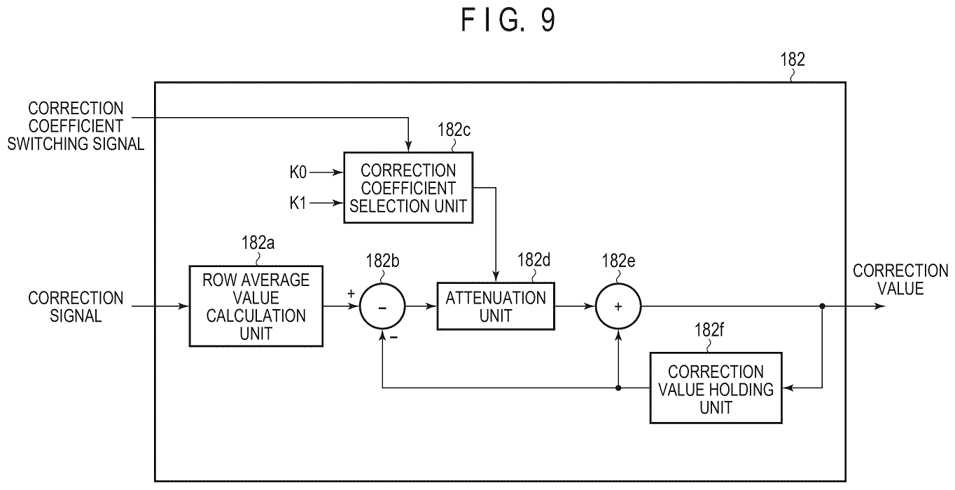

FIG. 9 is a block diagram of the correction value generation unit 182 according to the present embodiment. The correction value generation unit 182 includes a row average value calculation unit 182a, a subtraction unit 182b, a correction coefficient selection unit 182c, an attenuation unit 182d, an addition unit 182e, and a correction value holding unit 182f.

The correction value generation unit 182 performs filter processing with reference to three of a row average value of the correction signal calculated by the row average value calculation unit 182a, an attenuation coefficient set by the attenuation unit 182d, and a correction value held in the correction value holding unit 182f. A new correction value is generated by this filtering processing. In the present embodiment, the processing performed by the correction value generation unit 182 is processing of generating a correction value by performing digital low-pass filter processing on a correction signal for each row. The digital low-pass filter in the example of FIG. 9 is the IIR filter.

In the above-described filtering processing, it is desirable to use the IIR filter from the viewpoint of reducing the row variation. However, the processing of the correction value generation unit 182 is not limited to the processing using the IIR filter. For example, integral averaging may be used for the processing of the correction value generation unit 182.

The row average value calculation unit 182a calculates a row average value of the correction signals acquired in the correction signal acquisition regions 11b and 11c. The correction signals used to calculate the row average value may be acquired from the correction signal acquisition region 11c. This is because since the correction signals of the same row as the effective pixel region 11a can be acquired from the correction signal acquisition region 11c, the correction of the noise depending on the position of the pixel row can be effectively performed.

The row average value calculated by the row average value calculation unit 182a is input to the subtraction unit 182b. The subtraction unit 182b subtracts the correction value held in the correction value holding unit 182f from the row average value and outputs the result to the attenuation unit 182d.

The correction coefficient switching signal and correction coefficients K0 and K1 are input to the correction coefficient selection unit 182c. These control signals may be input from the control unit 12, may be input from the vertical scanning unit 13, may be input from another block of the photoelectric conversion device 1, or may be input from the outside of the photoelectric conversion device 1, for example. The correction coefficient switching signal is a signal for transmitting the timing of switching the correction coefficient to the correction coefficient selection unit 182c. This timing corresponds to the readout timing in the vicinity of the boundary between the region in which the pixels P from which signals are read out to the vertical output line Ha are arranged and the region in which the pixels P from which signals are read out to the vertical output line Hb are arranged. The correction coefficients K0 and K1 are attenuation coefficients of the attenuation processing performed in the attenuation unit 182d. The correction coefficient K0 and the correction coefficient K1 are different from each other.

The correction coefficient selection unit 182c selects one of the correction coefficient K0 and the correction coefficient K1 based on the correction coefficient switching signal and outputs the selected correction coefficient to the attenuation unit 182d. The correction coefficient selection unit 182c selects the correction coefficient K0 (first correction coefficient) when the correction coefficient switching signal is “0”, and selects the correction coefficient K1 (second correction coefficient) when the correction coefficient switching signal is “1”. The attenuation unit 182d attenuates the signal output from the subtraction unit 182b (a value obtained by subtracting the correction value from the row average value) in accordance with the correction coefficient selected by the correction coefficient selection unit 182c.

The signal obtained by the attenuation processing and output from the attenuation unit 182d is input to the addition unit 182e. The addition unit 182e adds the output signal of the attenuation unit 182d and the correction value held in the correction value holding unit 182f. The correction value thus newly obtained is output from the correction value generation unit 182 to the correction unit 181. In addition, the correction value is held in the correction value holding unit 182f, and is used to generate the correction value of the next row.

To summarize the above-described processing, the IIR filter processing performed by the loop including the subtraction unit 182b, the attenuation unit 182d, the addition unit 182e, and the correction value holding unit 182f is expressed by the following Expression (1).

$$( correction value of k - th row ) = ( attenuation coefficient ) \times ( row average value of k - th row ) + ( 1 - ( attenuation coefficient ) ) \times ( correction value of ( k - 1 ) - th row ) \qquad ( 1 )$$

Here, the “attenuation coefficient” in the Expression (1) is an attenuation coefficient of the attenuation unit 182d determined by the correction coefficient K0 or the correction coefficient K1, and is a value that is greater than zero and is equal to or less than one.

In the situation illustrated in FIGS. 7A and 7B, the correction coefficient switching signal is set to “1” immediately after the vertical output lines Ha and Hb from which signals are read are switched, that is, at the timing of reading the row V4 (second pixel row). At this time, the correction coefficient K1 is selected. On the other hand, at the timing of reading of each row in the region R1, that is, each of the row V3 and rows before the row V3 (third pixel row), the correction coefficient switching signal is set to “0”. At this time, the correction coefficient K0 is selected. The correction coefficient switching signal is also set to “0” at the timing of reading each row (first pixel row) other than the row V4 in the region R2. At this time, the correction coefficient K0 is selected.

The attenuation coefficient of the attenuation unit 182d set by the correction coefficient K1 may be less than the attenuation coefficient of the attenuation unit 182d set by the correction coefficient K0. By this setting, the followability of the IIR filter can be made higher in the case where the correction coefficient K1 is set than in the case where the correction coefficient K0 is set. Accordingly, the correction coefficient is switched at the timing when the vertical output lines Ha and Hb from which signals are read are switched, and the correction value can be generated with high followability. Therefore, since the followability of the correction is enhanced at the timing when the vertical output lines Ha and Hb from which signals are read are switched, the step due to the output line splitting can be corrected more effectively.

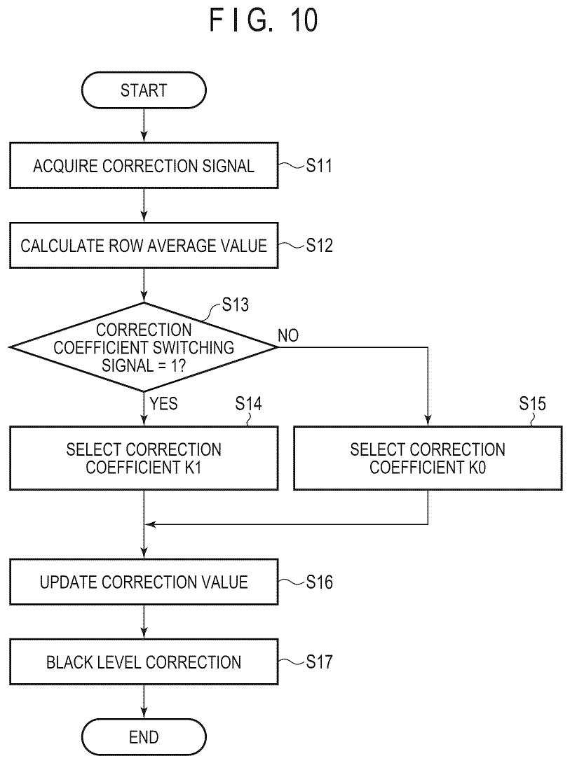

FIG. 10 is a flowchart illustrating a black level correction method according to the present embodiment. An example of a processing procedure in the signal processing unit 18 will be described. Description of the same portions as those in FIGS. 8 and 9 may be omitted or simplified as appropriate.

In step S11, the photoelectric conversion device 1 acquires correction signals from the correction signal acquisition region 11c of the pixel array 11. The correction signals are input to the row average value calculation unit 182a.

In step S12, the row average value calculation unit 182a calculates a row average value from the correction signals.

In step S13, the correction coefficient selection unit 182c determines whether the value of the correction coefficient switching signal being input is “1”. In the step S13, when the correction coefficient switching signal is “1” (YES in the step S13), the process proceeds to step S14. In the step S14, the correction coefficient selection unit 182c selects the correction coefficient K1 and outputs it to the attenuation unit 182d. Thereafter, the process proceeds to step S16.

In the step S13, when the correction coefficient switching signal is not “1” (NO in the step S13), the process proceeds to step S15. In the step S15, the correction coefficient selection unit 182c selects the correction coefficient K0 and outputs it to the attenuation unit 182d. Thereafter, the process proceeds to the step S16.

In the step S16, the subtraction unit 182b, the attenuation unit 182d, the addition unit 182e, and the correction value holding unit 182f generate a correction value by the above-described IIR filter. The generated correction value is held in the correction value holding unit 182f. As a result, the correction value held by the correction value holding unit 182f is updated. In addition, the correction value is output to the correction unit 181.

In step S17, the correction unit 181 performs the black level correction of the pixel signal by subtracting the updated correction value from the pixel signal acquired in the effective pixel region 11a.

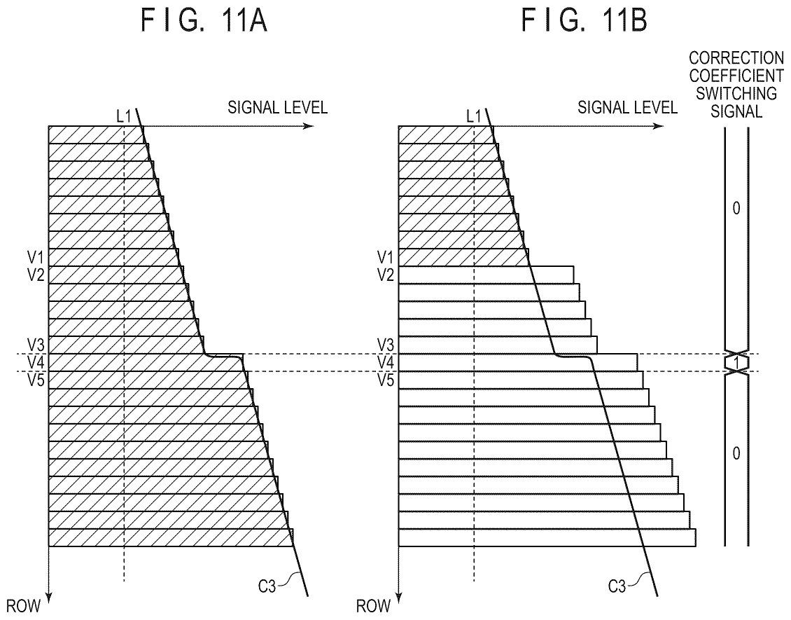

FIGS. 11A and 11B are diagrams schematically illustrating signal levels of respective rows before correction and the correction coefficient switching signal according to the present embodiment. FIGS. 11A and 11B illustrate changes in the correction value level C3 and the correction coefficient switching signal when the processing illustrated in FIGS. 8 to 10 is applied in a case where step-like noise is generated by the output line splitting as in FIGS. 7A and 7B. A row V5 (first pixel row) illustrated in FIGS. 11A and 11B is the next row of the row V4. That is, the row V5 is the second row in the region where the signals are read to the vertical output line Hb.

As illustrated in FIGS. 11A and 11B, the step due to the output line splitting is generated between the row V3 (the lowermost row of the region R1) and the row V4 (the uppermost row of the region R2) adjacent to the row V3. Therefore, the correction coefficient switching signal is “1” at the timing of reading the row V4, and the correction coefficient switching signal is “0” in the other periods. That is, the correction coefficient K1 is applied to the correction of the output signal of the row V4, and the correction coefficient K0 is applied to the correction of the output signal of the row other than the row V4 (the rows before the row V3, the row V3, the row V5, and the rows after the row V5). As a result, the followability in the correction of the output signal of the row V4 is improved. As illustrated in FIGS. 11A and 11B, the correction value level C3 generated using the output signals illustrated in FIG. 11A well follows the step due to the output line splitting.

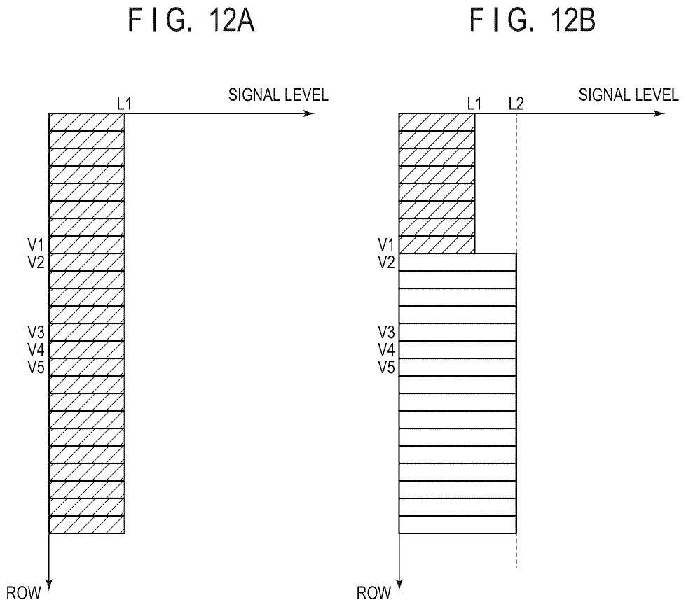

FIGS. 12A and 12B are diagrams schematically illustrating signal levels of respective rows after correction. As illustrated in FIG. 12A, the shading component and the component of the step due to the output line splitting are removed, and the signal level of each row is uniform. As illustrated in FIG. 12B, the shading component and the component of the step due to the output line splitting are removed, and the signal level is uniform in each of the correction signal acquisition region 11b and the effective pixel region 11a. As described above, in the examples of FIGS. 12A and 12B, the correction is appropriately performed even when the step due to the output line splitting is likely to occur.

In the present embodiment, as illustrated in FIG. 1, two vertical output lines are arranged so as to correspond to pixels P in one column. In such a configuration, as illustrated in FIGS. 7A and 7B, noise may occur in the output signal due to switching of the vertical output lines Ha and Hb from which the signals are read. In the present embodiment, the correction coefficient is switched at a timing at which the region R1 in which the pixel P to which the vertical output line Ha is connected is arranged and the region R2 in which the pixel P to which the vertical output line Hb is connected is arranged are switched during scanning. This switching is performed within one frame period in which the vertical scanning unit 13 performs one scanning.

By switching the correction coefficients as described above, it is possible to obtain a correction value that follows noise well. Therefore, according to the present embodiment, a photoelectric conversion device capable of improving the quality of an output image is provided.

In the generation and acquisition of the correction coefficient switching signal, a method of detecting the timing at which the vertical output lines Ha and Hb from which the signals are read are switched is not particularly limited. For example, the vertical scanning unit 13 may generate a flag for transmitting the switching timing, and the signal processing unit 18 may receive the flag. Accordingly, the signal processing unit 18 can appropriately set the switching timing of the correction coefficient. Further, the signal processing unit 18 may refer to the setting value indicating the above-described switching timing from the control unit 12, for example.

The correction coefficient switching signal may be the value “1” at which the correction coefficient K1 is selected not only at the moment when the vertical output lines Ha and Hb from which signals are read are switched but also for a predetermined period after the vertical output lines Ha and Hb from which signals are read are switched. In addition, the correction coefficient switching signal may be the value “1” at which the correction coefficient K1 is selected during a predetermined period from before the vertical output lines Ha and Hb from which signals are read are switched to after they are switched. That is, the correction coefficient switching signal may have the value “1” at which the correction coefficient K1 is selected within a predetermined number of row control periods including the timing at which the vertical output lines Ha and Hb from which signals are read are switched, and may have the value “0” at which the correction coefficient K0 is selected during other row control periods.

### Second Embodiment

In the present embodiment, a modification of the method of setting the correction coefficient will be described. In the present embodiment, description of elements common to those of the first embodiment may be omitted or simplified.

In the first embodiment, it is assumed that the difference in shading component between the region R1 in which the pixels P from which signals are read out to the vertical output line Ha are arranged and the region R2 in which the pixels P from which signals are read out to the vertical output line Hb are arranged is sufficiently small. Therefore, in the first embodiment, one correction coefficient K0 is applied to regions other than the boundary between these two regions. However, the shading component may be different between the region R1 and the region R2 due to a large difference in the paths of the vertical output lines Ha and Hb. In the present embodiment, a correction method in consideration of such a case will be described.

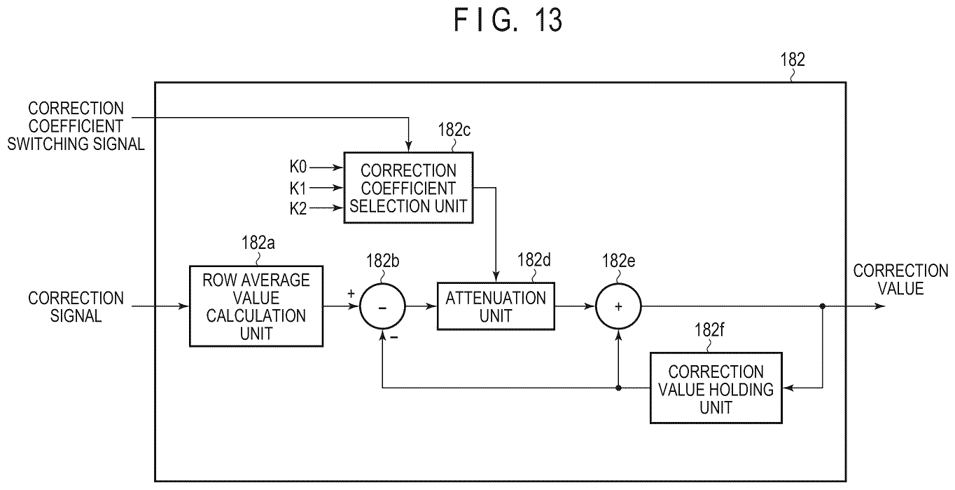

FIG. 13 is a block diagram of the signal processing unit 18 according to the present embodiment. In the present embodiment, the correction coefficient switching signal and correction coefficients K0, K1, and K2 are input to the correction coefficient selection unit 182c. That is, FIG. 13 is different from FIG. 8 in that three types of correction coefficients are input to the correction coefficient selection unit 182c. The correction coefficient switching signal has three values of “2”, “1”, and “0”. The correction coefficient selection unit 182c selects the correction coefficient K2 (second correction coefficient) when the correction coefficient switching signal is “2”, and selects the correction coefficient K1 (first correction coefficient) when the correction coefficient switching signal is “1”. The correction coefficient selection unit 182c selects the correction coefficient K0 (third correction coefficient) when the correction coefficient switching signal is “0”.

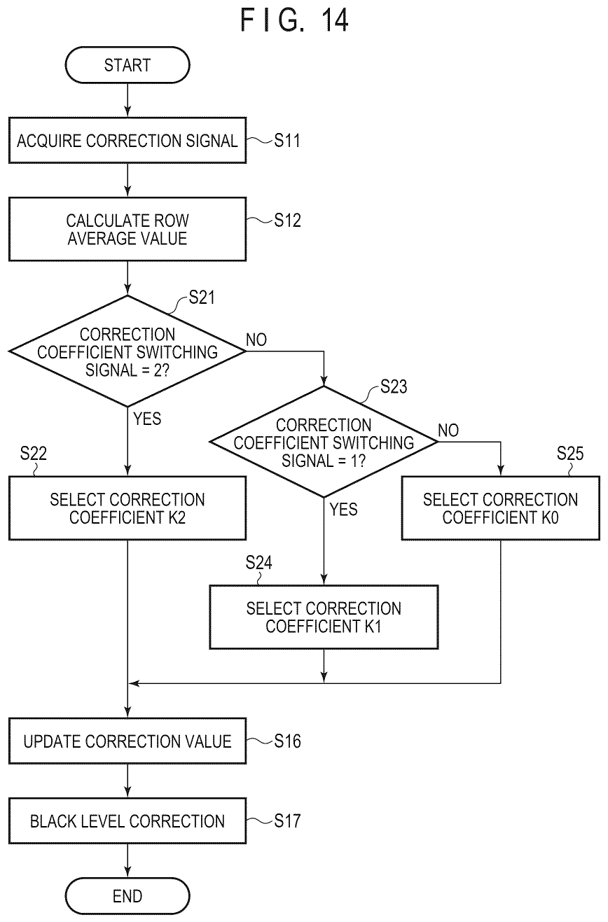

FIG. 14 is a flowchart illustrating a black level correction method according to the present embodiment. Since the processes of steps S11, S12, S16, and S17 are the same as those of FIG. 10, the description thereof will be omitted.

In step S21, the correction coefficient selection unit 182c determines whether the value of the correction coefficient switching signal being input is “2”. In the step S21, when the correction coefficient switching signal is “2” (YES in the step S21), the process proceeds to step S22. In the step S22, the correction coefficient selection unit 182c selects the correction coefficient K2 and outputs it to the attenuation unit 182d. Thereafter, the process proceeds to the step S16. In the step S21, when the correction coefficient switching signal is not “2” (NO in the step S21), the process proceeds to step S23.

In the step S23, the correction coefficient selection unit 182c determines whether the value of the input correction coefficient switching signal being input is “1”. In the step S23, when the correction coefficient switching signal is “1” (YES in the step S23), the process proceeds to step S24. In the step S24, the correction coefficient selection unit 182c selects the correction coefficient K1 and outputs it to the attenuation unit 182d. Thereafter, the process proceeds to the step S16. In the step S23, when the correction coefficient switching signal is not “1” (NO in the step S23), the process proceeds to step S25. In the step S25, the correction coefficient selection unit 182c selects the correction coefficient K0 and outputs it to the attenuation unit 182d. Thereafter, the process proceeds to the step S16.

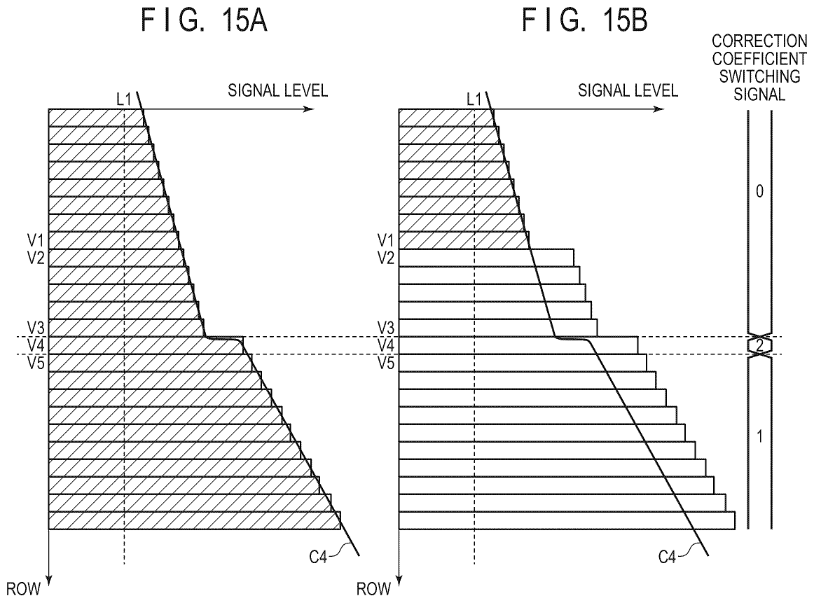

FIG. 15A and FIG. 15B are diagrams schematically illustrating the signal levels of respective rows before correction and the correction coefficient switching signal according to the present embodiment. FIGS. 15A and 15B illustrate changes in correction value level C4 and the correction coefficient switching signal. Similarly to FIGS. 11A and 11B, in FIGS. 15A and 15B, the step due to the output line splitting is generated between the row V3 and the row V4. At the timing of reading the row V4, the correction coefficient switching signal is “2”, and the correction coefficient K2 is applied to the correction of the output signal of the row V4. At the timings of reading the row V3 and the rows before the row V3, the correction coefficient switching signal is “0”, and the correction coefficient K0 is applied to the correction of the output signals of the row V3 and the rows before the row V3. The correction coefficient switching signal is “1” at the timing of reading out the row V5 and the rows after the row V5, and the correction coefficient K1 is applied to the correction of the output signals of the row V5 and the rows after the row V5.

The attenuation coefficient of the attenuation unit 182d set by the correction coefficient K2 may be less than the attenuation coefficient of the attenuation unit 182d set by the correction coefficients K0 and K1. By this setting, the followability of the IIR filter can be made higher in the case where the correction coefficient K2 is set than in the case where the correction coefficients K0 and K1 are set. Accordingly, the correction coefficient is switched at the timing when the vertical output lines Ha and Hb from which signals are read are switched, and the correction value can be generated with high followability. This makes it possible to effectively correct the influence of the step due to the output line splitting.

Further, in the present embodiment, the correction coefficient K0 applied to the correction of the output signal of the row V3 and the rows before the row V3 and the correction coefficient K1 applied to the correction of the output signal of the row V5 and the rows after the row V5 are different from each other. As a result, correction can be performed in consideration of the difference in shading components of the rows before and after the row V4. For example, as illustrated in FIGS. 15A and 15B, it is assumed that the shading component of the row V5 and the rows after the row V5 is greater than the shading component of the row V3 and the rows before the row V3. In this case, the attenuation coefficient of the attenuation unit 182d set by the correction coefficient K1 may be less than the attenuation coefficient of the attenuation unit 182d set by the correction coefficient K0. According to this setting, the followability of the IIR filter can be made higher in the case where the correction coefficient K1 is set than in the case where the correction coefficient K0 is set, and the shading component can be corrected more effectively.

As described above, according to the present embodiment, in addition to the same effects as those of the first embodiment, a suitable correction is performed even when the shading characteristics change before and after the row in which the vertical output lines Ha and Hb from which signals are read are switched. Therefore, according to the present embodiment, a photoelectric conversion device capable of improving the quality of an output image is provided.

### Third Embodiment

In the present embodiment, a modification of the arrangement of the vertical output lines and the setting method of the correction coefficients will be described. In the present embodiment, description of elements common to the first embodiment or the second embodiment may be omitted or simplified.

In the first embodiment and the second embodiment, an example is illustrated in which two vertical output lines are arranged so as to correspond to pixels P in one column. In this case, the timing at which the vertical output line from which the signals are read is switched for one scan is one time. However, three or more vertical output lines may be arranged so as to correspond to the pixels P in one column. In this case, the timings at which the vertical output line from which the signals are read is switched with respect to one scan are two or more times. In the present embodiment, a correction method in consideration of a case where three vertical output lines are arranged so as to correspond to pixels P in one column will be described. The same applies to a case where four or more vertical output lines are arranged so as to correspond to the pixels P in one column.

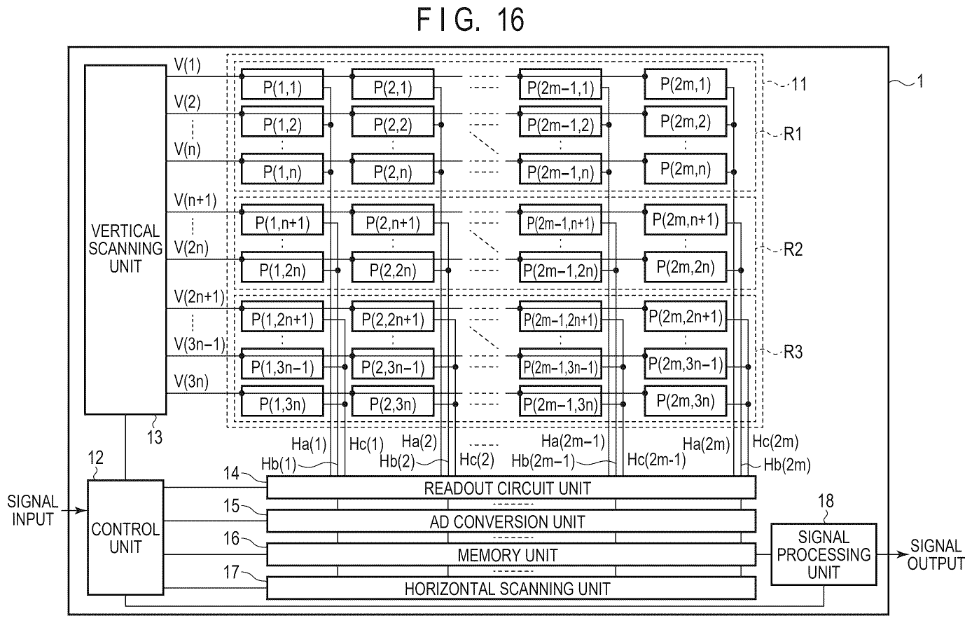

FIG. 16 is a block diagram illustrating a configuration example of the photoelectric conversion device 1 according to the present embodiment. Differences between FIG. 16 and FIG. 1 will be mainly described. The pixel array 11 includes a plurality of pixels P arranged to form a plurality of rows and a plurality of columns. The pixel P may include the photoelectric conversion element. In FIG. 16, pixels P arranged in a matrix of 2m columns×3n rows are illustrated as rectangular blocks. The vertical scanning unit 13 supplies control signals to the pixels P on a row basis via control lines V(1) to V(3n) arranged for each row of the pixel array 11.

In the present embodiment, in addition to the vertical output lines Ha(1) to Ha(2m) and the vertical output lines Hb(1) to Hb(2m), vertical output lines Hc(1) to Hc(2m) are further arranged so as to correspond to the first to the 2m-th columns, respectively. Each of the vertical output lines Hc(1) to Hc(2m) (third output line) is connected to the pixels P in the (2n+1)-th row to the 3n-th row of the corresponding column in the region R3 (third region). In the present embodiment, three vertical output lines are arranged so as to correspond to the pixels P in one column.

The configuration of the correction value generation unit 182 of the present embodiment is the same as that of FIG. 13. That is, the values of the correction coefficient switching signals are three types of “2”, “1”, and “0”. The correction coefficient selection unit 182c selects the correction coefficient K2 (fourth correction coefficient) when the correction coefficient switching signal is “2”, selects the correction coefficient K1 (second correction coefficient) when the correction coefficient switching signal is “1”, and selects the correction coefficient K0 (first correction coefficient) when the correction coefficient switching signal is “0”.

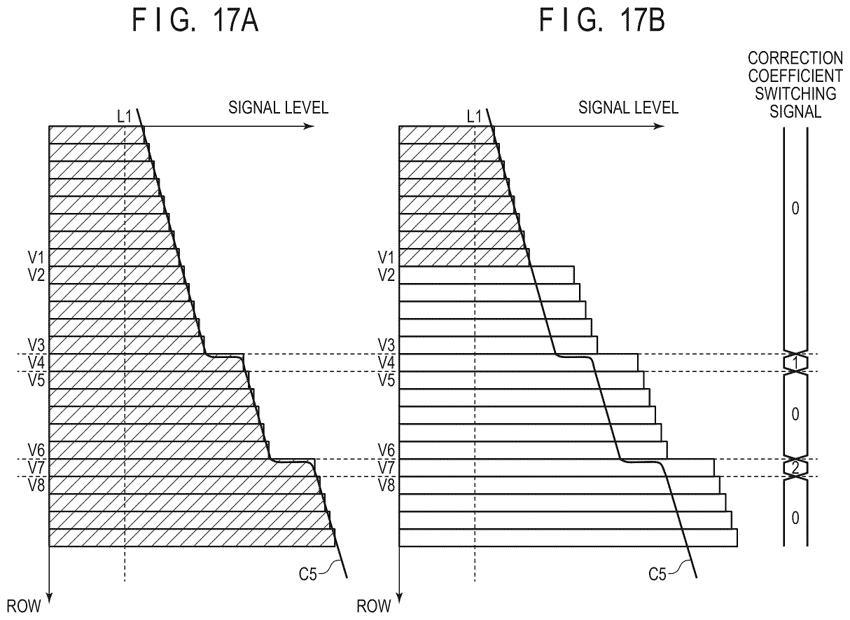

FIG. 17A and FIG. 17B are diagrams schematically illustrating the signal levels of respective rows before correction and the correction coefficient switching signal according to the present embodiment. In FIGS. 17A and 17B, the row V3 is the lowermost row of the region where signals are read to the vertical output line Ha, and the row V4 is the uppermost row of the region where signals are read to the vertical output line Hb. The row V5 is the next row of the row V4. That is, the row V5 is the second row in the region where the signals are read to the vertical output line Hb. Further, a row V6 is the lowermost row of the region where the signals are read to the vertical output line Hb, and a row V7 (fourth pixel row) is the uppermost row of a region where the signals are read to the vertical output line Hc. A row V8 is the next row of the row V7. That is, the row V8 is the second row in the region where the signals are read to the vertical output line Hc.

As illustrated in FIGS. 17A and 17B, the steps due to the output line splitting are generated at two positions between the row V3 and the row V4 and between the row V6 and the row V7. Therefore, the correction coefficient switching signal is “1” at the timing of reading the row V4, the correction coefficient switching signal is “2” at the timing of reading the row V7, and the correction coefficient switching signal is “0” in the other periods. That is, the correction coefficient K1 is applied to the correction of the output signals of the row V4, the correction coefficient K2 is applied to the correction of the output signals of the row V7, and the correction coefficient K0 is applied to the correction of the output signals of the other rows. This improves the followability in correcting the output signals of the row V4 and the row V7. As illustrated in FIGS. 17A and 17B, a correction value level C5 generated using the output signal illustrated in FIG. 17A well follows the step due to the output line splitting.

The attenuation coefficient of the attenuation unit 182d set by the correction coefficients K1 and K2 may be less than the attenuation coefficient of the attenuation unit 182d set by the correction coefficient K0. By this setting, the followability of the IIR filter can be made higher in the case where the correction coefficients K1 and K2 are set than in the case where the correction coefficient K0 is set. Accordingly, the correction coefficient is switched at the timing when the vertical output lines Ha, Hb, and Hc from which signals are read are switched, and the correction value can be generated with high followability. This makes it possible to effectively correct the influence of the steps due to the output line splitting.

As in the present embodiment, three or more vertical output lines may be arranged so as to correspond to the pixels P in one column. In this case, as described above, the timings at which the vertical output line from which the signals are read is switched with respect to one scan is two or more times. By switching the correction coefficient at each timing at which the vertical output line is switched, the steps due to the output line splitting are suitably corrected. Therefore, according to the present embodiment, a photoelectric conversion device capable of improving the quality of an output image is provided.

The correction coefficient K1 and the correction coefficient K2 may be different values or may be the same value. Further, as in the second embodiment, the correction coefficient applied to the correction of the output signals of the row V3 and the rows before the row V3 and the correction coefficient applied to the correction of the output signals of the row V5 to the row V6 may be different from each other. Further, the correction coefficient applied to the correction of the output signals of the row V5 to the row V6 may be different from the correction coefficient applied to the correction of the output signals of the row V8 and the rows after the row V8.

### Fourth Embodiment

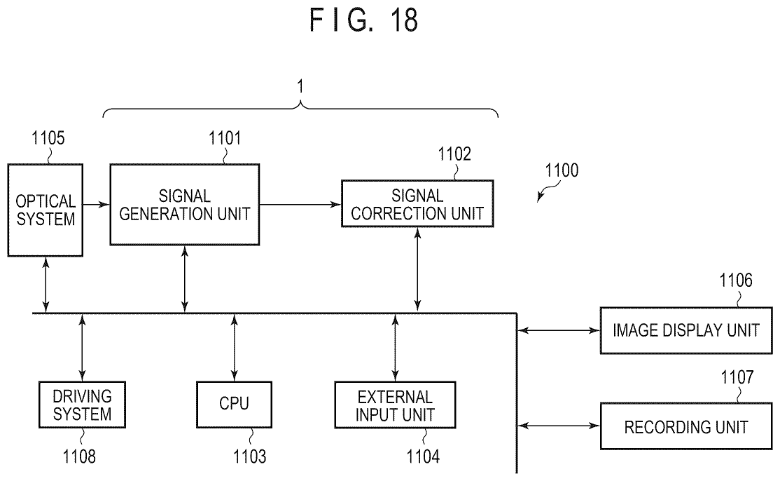

FIG. 18 is a diagram illustrating a configuration example of an imaging system 1100 according to the present embodiment. The imaging system 1100 is an example of equipment in which the photoelectric conversion devices 1 according to the first to third embodiments are incorporated. The imaging system 1100 includes a signal generation unit 1101, a signal correction unit 1102, a CPU 1103, an external input unit 1104, an optical system 1105, an image display unit 1106, a recording unit 1107, and a driving system 1108.

The signal correction unit 1102 may be the signal processing unit 18 described above. The signal generation unit 1101 may include the pixel array 11, the control unit 12, the vertical scanning unit 13, the readout circuit unit 14, the AD conversion unit 15, the memory unit 16, the horizontal scanning unit 17, and the like. Therefore, the signal generation unit 1101 and the signal correction unit 1102 may be the photoelectric conversion device 1 described above.

The optical system 1105 is a portion that causes light to enter the light receiving portion of the signal generation unit 1101, and may include a lens, an aperture, and the like. The signal generation unit 1101 photoelectrically converts incident light to generate an analog image signal. The signal generation unit 1101 performs AD conversion on the analog signal to generate and output image data. The signal correction unit 1102 corrects the image data so that the image data can be output to and stored in the image display unit 1106 or the recording unit 1107. The image display unit 1106 displays an image using the display image data subjected to the correction processing. The recording unit 1107 stores the display image data. The CPU 1103 is a processor that performs overall control of the imaging system 1100 and arithmetic processing. The driving system 1108 performs, for example, adjustment of the focus, adjustment of the aperture, and the like of the optical system 1105. The external input unit 1104 may be a button or the like for the user to input imaging conditions, operate a shutter, or the like. The image display unit 1106 may be a touch panel, and the touch panel may function as a part of the external input unit 1104.

According to the present embodiment, equipment in which the photoelectric conversion device 1 according to the first to third embodiments is incorporated is provided.

### Fifth Embodiment

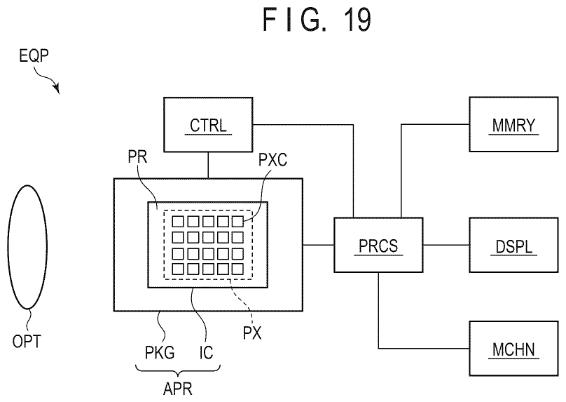

Equipment according to a fifth embodiment of the present disclosure will be described with reference to FIG. 19. FIG. 19 is a block diagram illustrating a schematic configuration of the equipment according to the present embodiment.

FIG. 19 is a schematic diagram illustrating equipment EQP including a photoelectric conversion device APR. The photoelectric conversion device APR has the functions of the photoelectric conversion devices 1 according to the first to third embodiments. A part of or the entire photoelectric conversion device APR is a semiconductor device IC. The photoelectric conversion device APR according to this example can be used as, for example, an image sensor, an auto focus (AF) sensor, a photometric sensor, a ranging sensor, or the like. The semiconductor device IC has a pixel area PX in which pixel circuits PXC each including a photoelectric conversion unit are arranged in a matrix. The semiconductor device IC can have a peripheral area PR around the pixel area PX. Circuits other than the pixel circuits can be arranged in the peripheral area PR.

The photoelectric conversion device APR may have a structure (chip stacked structure) in which a first semiconductor chip in which a plurality of photoelectric conversion units are provided and a second semiconductor chip in which peripheral circuits are provided are stacked. Each of the peripheral circuits in the second semiconductor chip can be a column circuit corresponding to a pixel column of the first semiconductor chip. In addition, each of the peripheral circuits in the second semiconductor chip can be a matrix circuit corresponding to a pixel or a pixel block of the first semiconductor chip. A through electrode (TSV), an inter-chip wiring by direct bonding of a conductor such as copper, connection by a microbump between chips, connection by wire bonding, or the like can be adopted for connection between the first semiconductor chip and the second semiconductor chip.

The photoelectric conversion device APR can include a package PKG that accommodates the semiconductor device IC in addition to the semiconductor device IC. The package PKG can include a base to which the semiconductor device IC is fixed, a lid body such as glass facing the semiconductor device IC, and a connection member such as a bonding wire or a bump that connects a terminal provided on the base and a terminal provided on the semiconductor device IC.

The equipment EQP can further include at least one of an optical device OPT, a control device CTRL, a processing device PRCS, a display device DSPL, a storage device MMRY, and a mechanical device MCHN. The optical device OPT corresponds to the photoelectric conversion device APR as the photoelectric conversion device, and is, for example, a lens, a shutter, or a mirror. The control device CTRL controls the photoelectric conversion device APR, and is, for example, a semiconductor device such as an application specific integrated circuit (ASIC). The processing device PRCS processes a signal output from the photoelectric conversion device APR, and forms an analog front end (AFE) or a digital front end (DFE). The processing device PRCS is a semiconductor device such as a CPU or an ASIC. The display device DSPL is an EL display device, a liquid crystal display device, or the like that displays information (image) obtained by the photoelectric conversion device APR. The storage device MMRY is a magnetic device, a semiconductor device, or the like that stores information (image) obtained by the photoelectric conversion device APR. The storage device MMRY is a volatile memory such as a static random access memory (SRAM) or a dynamic random access memory (DRAM), or a nonvolatile memory such as a flash memory or a hard disk drive. The mechanical device MCHN includes a movable unit such as a motor or an engine, or a propulsion unit. In the equipment EQP, a signal output from the photoelectric conversion device APR is displayed on the display device DSPL or transmitted to the outside by a communication device (not illustrated) included in the equipment EQP. Therefore, the equipment EQP preferably further includes the storage device MMRY and the processing device PRCS in addition to a storage circuit unit and an arithmetic circuit unit included in the photoelectric conversion device APR.

The equipment EQP illustrated in FIG. 19 can be electronic equipment such as an information terminal (for example, a smartphone or a wearable terminal) having a photographing function or a camera (for example, an interchangeable-lens camera, a compact camera, a video camera, or a monitoring camera). The mechanical device MCHN in the camera can drive parts of the optical device OPT for zooming, focusing, and shutter operation. In addition, the equipment EQP may be transport equipment (moving body) such as a vehicle, a ship, or a flying body. In addition, the equipment EQP may be medical equipment such as an endoscope or a computed axial tomography (CT) scanner.

The mechanical device MCHN in the transport equipment can be used as a mobile device. The equipment EQP as the transport equipment is suitable for transporting the photoelectric conversion device APR, assisting and/or automating driving (steering) by the photographing function, and the like. The processing device PRCS for assisting and/or automating driving (steering) can execute processing for operating the mechanical device MCHN as the mobile device based on information obtained by the photoelectric conversion device APR.

The photoelectric conversion device APR according to the present embodiment can provide a high value to a designer, a manufacturer, a seller, a purchaser, and/or a user thereof. Therefore, if the photoelectric conversion device APR is mounted on the equipment EQP, the value of the equipment EQP can also be increased. Therefore, in manufacturing and selling the equipment EQP, it is advantageous to determine mounting of the photoelectric conversion device APR according to the present embodiment on the equipment EQP in order to increase the value of the equipment EQP.

### Sixth Embodiment

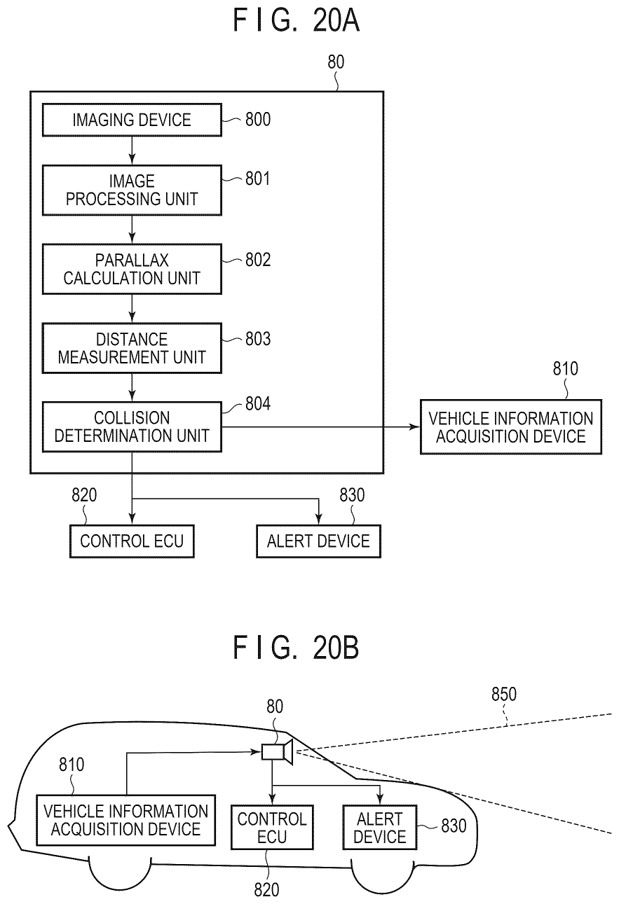

FIGS. 20A and 20B are block diagrams of equipment relating to the vehicle-mounted camera according to the present embodiment. FIGS. 20A and 20B illustrate an example in which the photoelectric conversion device 1 (an example of the photoelectric conversion device) is applied to a movable body such as a vehicle. The equipment 80 includes an imaging device 800 and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80. The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the present embodiment, an image of the periphery of the vehicle, for example, the front or the rear is captured by the equipment 80. FIG. 20B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Other Embodiments

The present disclosure is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the present disclosure.

Also, the disclosure of the present specification includes a complementary set of the concepts described in the present specification. In other words, for example, when there is a description of “A is greater than B” in the present specification, it can be said that the description of “A is not greater than B” is disclosed in the present specification even when the description of “A is not greater than B” is omitted. This is because it is assumed that the case where “A is not greater than B” is considered when “A is greater than B” is described.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for carrying out the present disclosure, and the technical scope of the present disclosure should not be interpreted in a limited manner by these embodiments. That is, the present disclosure can be implemented in various forms without departing from the technical idea or the main features thereof.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-221691, filed Dec. 18, 2024, which is hereby incorporated by reference herein in its entirety.

What is claimed is:

1. A photoelectric conversion device comprising:
a pixel array including a plurality of pixels arranged to form a plurality of rows and a plurality of columns;
a first output line and a second output line each arranged to correspond to one of the plurality of columns; and
a correction value generation unit configured to generate a correction value used for black level correction of a signal output from the pixel array,
wherein the pixel array includes a first region including consecutive rows among the plurality of rows and a second region including other consecutive rows among the plurality of rows, the second region being adjacent to the first region,
wherein each row of the first region and the second region includes an effective pixel region configured to output a signal according to incident light by photoelectric conversion and a correction signal acquisition region configured to output a correction signal,
wherein the first output line is connected to a pixel in the first region and is not connected to any pixel in the second region,
wherein the second output line is connected to a pixel in the second region and is not connected to any pixel in the first region,
wherein the second region includes a first pixel row and a second pixel row that is adjacent to the first region, and
wherein the correction value generation unit generates a correction value used for black level correction of a signal output from a pixel of the first pixel row based on a first correction coefficient and the correction signal, and generates a correction value used for black level correction of a signal output from a pixel of the second pixel row based on a second correction coefficient different from the first correction coefficient and the correction signal.

2. The photoelectric conversion device according to claim 1,
wherein the first region includes a third pixel row, and
wherein the correction value generation unit generates a correction value used for black level correction of a signal output from a pixel of the third pixel row based on the first correction coefficient and the correction signal.

3. The photoelectric conversion device according to claim 2, wherein the third pixel row is adjacent to the second region.

4. The photoelectric conversion device according to claim 1,
wherein the first region includes a third pixel row, and
wherein the correction value generation unit generates a correction value used for black level correction of a signal output from a pixel of the third pixel row based on a third correction coefficient different from both the first correction coefficient and the second correction coefficient and the correction signal.

5. The photoelectric conversion device according to claim 4, wherein the third pixel row is adjacent to the second region.

6. The photoelectric conversion device according to claim 1 further comprising a third output line arranged to correspond to the one of the plurality of columns,
wherein the third output line is connected to a pixel in a third region including other consecutive rows among the plurality of rows, the third region being adjacent to the second region,
wherein the first output line is not connected to any pixel in the third region,
wherein the second output line is not connected to any pixel in the third region,
wherein the third output line is not connected to any pixel in the first region and any pixel in the second region,
wherein the third region includes a fourth pixel row adjacent to the second region, and
wherein the correction value generation unit generates a correction value used for black level correction of a signal output from a pixel of the fourth pixel row based on a fourth correction coefficient different from the first correction coefficient.

7. The photoelectric conversion device according to claim 1, wherein the correction value generation unit includes a low-pass filter.

8. The photoelectric conversion device according to claim 7, wherein the first correction coefficient and the second correction coefficient correspond to attenuation coefficients of the low-pass filter.

9. The photoelectric conversion device according to claim 8, wherein an attenuation coefficient of the low-pass filter based on the second correction coefficient is less than an attenuation coefficient of the low-pass filter based on the first correction coefficient.

10. The photoelectric conversion device according to claim 7, wherein the low-pass filter is an infinite impulse response (IIR) filter.

11. The photoelectric conversion device according to claim 1,
wherein a pixel in the effective pixel region includes a photoelectric conversion element, and
wherein a pixel in the correction signal acquisition region includes a photoelectric conversion element and a light shielding portion that shields incident light to the photoelectric conversion element.

12. The photoelectric conversion device according to claim 1,
wherein a pixel in the effective pixel region includes a photoelectric conversion element, and
wherein a pixel in the correction signal acquisition region does not include a photoelectric conversion element.

13. The photoelectric conversion device according to claim 1 further comprising a pixel control unit configured to scan the plurality of pixels so that the plurality of pixels sequentially output signals on a row basis.

14. The photoelectric conversion device according to claim 13, wherein the correction value generation unit switches between a state of generating a correction value based on the first correction coefficient and a state of generating a correction value based on the second correction coefficient within one frame period in which the pixel control unit performs one scan.

15. The photoelectric conversion device according to claim 13, wherein the pixel control unit outputs a signal indicating a switching timing of the first correction coefficient and the second correction coefficient to the correction value generation unit.

16. The photoelectric conversion device according to claim 1, wherein the correction value generation unit generates a correction value based on an average value of the correction signals output from pixels in one row of the correction signal acquisition region.

17. The photoelectric conversion device according to claim 1,
wherein the pixel array is arranged in a first substrate, and
wherein the correction value generation unit is arranged in a second substrate stacked on the first substrate.

18. The photoelectric conversion device according to claim 17, wherein at least a part of the first output line and at least a part of the second output line are arranged on the first substrate.

19. Equipment comprising:
the photoelectric conversion device according to claim 1; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

20. The equipment according to claim 19, wherein the processing device acquires information on a distance from the photoelectric conversion device to an object.
